(19) United States
(12) Patent Application Publication
(10) Pub. No.: US 2022/0055054 A1
(43) Pub. Date: Feb. 24, 2022

(54) COSMETIC CONTAINER ASSEMBLY CAPABLE OF SIMULTANEOUSLY DISCHARGING MULTIPLE KINDS OF CONTENTS

(71) Applicant: APOLLO INDUSTRIAL CO., LTD., Siheung-si (KR)

(72) Inventors: Yong Dae LEE, Seoul (KR); Jae Kyung LEE, Incheon (KR)

(73) Assignee: APOLLO INDUSTRIAL CO., LTD.

(21) Appl. No.: 17/462,760

(22) Filed: Aug. 31, 2021

Related U.S. Application Data
(63) Continuation of application No. PCT/KR2020/011145, filed on Aug. 21, 2020.

(51) Int. Cl. B05B 11/00; A45D 34/00; B65D 81/32

(52) U.S. Cl. CPC B05B 11/3081; A45D 34/00; A45D 2200/055; B05B 11/3011; B05B 11/3056; B65D 81/325

(57) ABSTRACT

A cosmetic container assembly capable of simultaneously discharging multiple kinds of contents through a single pumping action is disclosed. The cosmetic container assembly includes a plurality of cosmetic containers, each of which includes a container and a pump dispenser capable of pumping and extruding the contents in the container through a piston rods, a base including a button-supporting shaft, a press plate, through which the button-supporting shaft extends, the press plate including connection ports fitted over the piston rods, a discharge port, discharge channels connecting the connection ports with the discharge port, and a support shaft, and a lever push button, which presses the support shaft and the press plate and thus simultaneously presses the pump dispensers to perform a pumping action when the lever push button is pressed.

### CROSS REFERENCES TO RELATED APPLICATION

This application is a continuation of PCT/KR2020/011145, filed Aug. 21, 2020, the entire disclosure of which is incorporated herein by reference.

### TECHNICAL FIELD

The present invention relates to a cosmetic container assembly, and more particularly to a cosmetic container assembly capable of simultaneously discharging multiple kinds of contents contained in a plurality of containers while mixing the contents with each other through a single pumping action.

### BACKGROUND ART

In general, a liquid or paste cosmetic preparation (hereinafter, referred to as liquid contents) is contained in a cosmetic container equipped with a pump dispenser. A predetermined amount of the liquid contents contained in the cosmetic container is discharged and used whenever the push head of the pump dispenser is pressed.

These days, dual-type cosmetic preparations, which are capable of realizing two effects using a single product, are commercially available. For example, there are cosmetic products in which a base material in a paste form and a powder or liquid ingredient capable of producing a specific effect such as whitening are mixed together and then used. Because there is the concern of rapid deterioration of the base material and the powder or liquid ingredient of such dual-type cosmetic preparations when the base material and the powder or liquid ingredient are mixed with each other in advance, the dual-type cosmetic preparations are configured such that the base material and the powder or liquid ingredient are directly mixed with each other by a user prior to use. Accordingly, there is demand for a dual-type cosmetic container capable of discharging multiple kinds of cosmetic contents while mixing them with each other. Such a dual-type cosmetic container is disclosed in Korea Patent Registration No. 10-1446612.

The cosmetic container disclosed in Korea Patent Registration No. 10-1446612, which aims to provide a cosmetic container capable of separately containing two kinds of contents and of discharging them, characteristically includes a container unit, which is constituted by a first container containing a first composition and a second container containing a second composition in which the first and second containers are coupled to each other so as to define a cylindrical form, a first airless pump module mounted on the first container, a second airless pump module mounted on the second container, and a push unit, which is constituted by a first push cap, which is mounted on the first airless pump module and has therein a first discharge hole, and a second push cap, which is mounted on the second airless pump module and has therein a second discharge hole. Consequently, a user is able to discharge and use only the composition contained in the first container or the second container by pressing the first push cap or the second push cap or to simultaneously discharge and use both the compositions contained in the first and second containers by simultaneously pressing both the first and second push caps.

However, the dual-type cosmetic container has a disadvantage in that one of the compositions in the two containers is first exhausted whereas some of the other of the compositions remains in the container when the two compositions are dispensed separately by pressing respective push caps. Meanwhile, the dual-type cosmetic container is used in such a way as to simultaneously discharge the compositions contained in the first and second containers by simultaneously pressing the first and second push caps. In this case, there is inconvenience in use in that the first and second push caps must be pressed with considerable force using the thumb.

### DISCLOSURE

### Technical Problem

Therefore, the present invention has been made in view of the above problems, and it is an object of the present invention to provide a cosmetic container assembly which is capable of simultaneously discharging multiple kinds of contents contained in a plurality of containers through a single pumping action and which enables pump dispensers mounted on the plurality of containers to be simultaneously pumped or operated even when the pump dispensers are lightly pressed.

### Technical Solution

In accordance with the present invention, the above and other objects can be accomplished by the provision of a cosmetic container assembly capable of simultaneously discharging multiple kinds of contents through a single pumping action including a plurality of cosmetic containers, each of which includes a container, which contains contents therein and is open at an upper end thereof, and a pump dispenser, which is mounted in the open end of the container and is capable of pumping the contents in the container to extrude the contents upwards through a hollow piston rod by repeated pressing action of the hollow piston rod, a base, on which the plurality of cosmetic containers are disposed at regular intervals and which is provided in the center thereof with a button-supporting shaft, which extends upwards, a press plate, which is horizontally disposed above the cosmetic containers and through a central region of which the button-supporting shaft extends, the press plate including connection ports formed in the lower surface thereof at regular intervals so as to allow upper ends of the piston rods of the pump dispensers to be fitted thereinto, a discharge port formed in a periphery thereof so as to discharge the contents, discharge channels formed therein so as to connect the connection ports with the discharge port, and a support shaft formed on an upper surface thereof so as to project upwards, and a lever push button, which is rotatably coupled at a front end thereof to an upper end of the button-supporting shaft and is provided on a lower surface of the front end thereof with a press protrusion configured to press the support shaft of the press plate and which is configured to move the press plate downwards and thus to press the pump dispensers of the cosmetic containers simultaneously to perform a pumping action when the rear end of the lever push button is pressed.

The press plate may include a shaft guide, which is formed around a shaft through hole, through which the button-supporting shaft extends, so as to surround the outer surface of the button-supporting shaft such that the press plate is moved upwards and downwards along the button-supporting shaft without inclination thereof.

The cosmetic container assembly may further include a container housing, which is disposed around the cosmetic containers and the press plate so as to surround the same.

### Advantageous Effects

The cosmetic container assembly capable of simultaneously discharging multiple kinds of contents according to the present invention, which is constructed as described above, has an advantage in that, when the rear end of the lever push button is pressed, the press plate is moved downwards and thus the pump dispensers of the cosmetic containers are pressed simultaneously so as to simultaneously discharge the contents while mixing the same with each other. Particularly, since the pump dispensers of the cosmetic containers are simultaneously pumped by lightly pressing the rear end of the push button, which adopts the principle of a lever, it is possible to improve convenience in use. Furthermore, since the various kinds of contents in the cosmetic containers are discharged in equal amounts through a single pumping action, there is a functional effect of preventing contents from remaining in any of the cosmetic containers.

In addition, since the cosmetic container assembly capable of simultaneously discharging multiple kinds of contents according to the present invention is constructed such that the press plate is moved upwards and downwards without inclination thereof by virtue of the shaft guide surrounding the button-supporting shaft, there is an advantage in that it is possible to actuate the pump dispensers of the cosmetic containers so as to perform pumping equally.

Furthermore, since the cosmetic container assembly capable of simultaneously discharging multiple kinds of contents according to the present invention is constructed such that the container housing surrounds the cosmetic containers and the press plate, it is possible to improve the aesthetic appearance of the cosmetic container assembly.

### DESCRIPTION OF DRAWINGS

The above and other objects, features and other advantages of the present invention will be more clearly understood from the following detailed description taken in conjunction with the accompanying drawings, in which:

FIG. 1 is a perspective view illustrating a cosmetic container assembly according to the present invention;

FIG. 2 is an exploded perspective view illustrating the overall structure of the cosmetic container assembly according to the present invention;

FIG. 3 is a cross-sectional view taken along line in FIG. 1;

FIG. 4 is an exploded perspective view of the coupling structure between cosmetic containers, a press plate, and a lever push button according to the present invention;

FIG. 5 is a perspective view illustrating the bottom structure of the press plate according to the present invention;

FIG. 6 is a schematic view illustrating the internal structure of the press plate according to the present invention;

FIG. 7 is a bottom perspective view illustrating the internal structure of the push button according to the present invention; and

FIG. 8 is a cross-sectional view illustrating the operation of the cosmetic container assembly according to the present invention.

<Description of Reference Numerals>

| 100.. cosmetic container | 110.. container |
|---|---|
| 120.. pump dispenser | 121.. cap |
| 122.. cylinder | 123.. pressure chamber |
| 124.. suction tube | 125.. piston rod |
| 126.. coil spring | 127.. inlet port |
| 128.. check valve | 200.. base |
| 210.. seating recess | |
| 220.. button-support shaft | 300.. press plate |
| 310.. connection port | 320.. discharge port |
| 330, 331, 332.. discharge channel | |
| 340.. support shaft | 350.. shaft through hole |
| 360.. shaft guide | 400.. lever push button |
| 410.. shaft | 420.. press protrusion |
| 500.. container housing | 510.. opening slot |

### BEST MODE

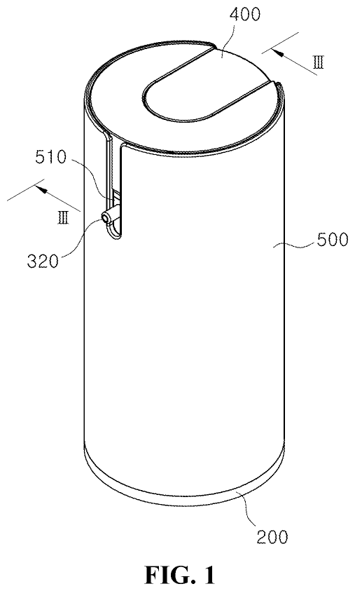

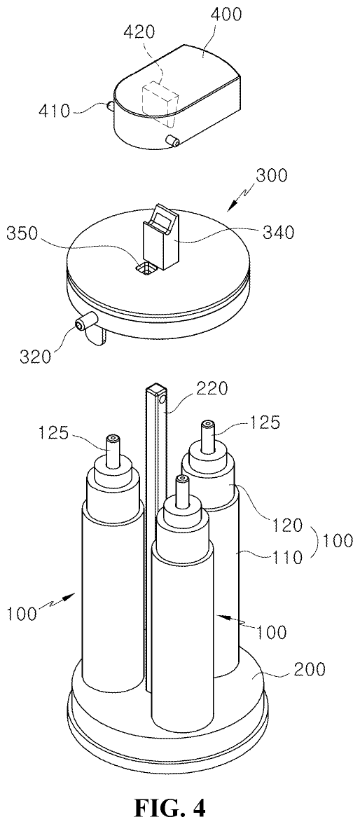

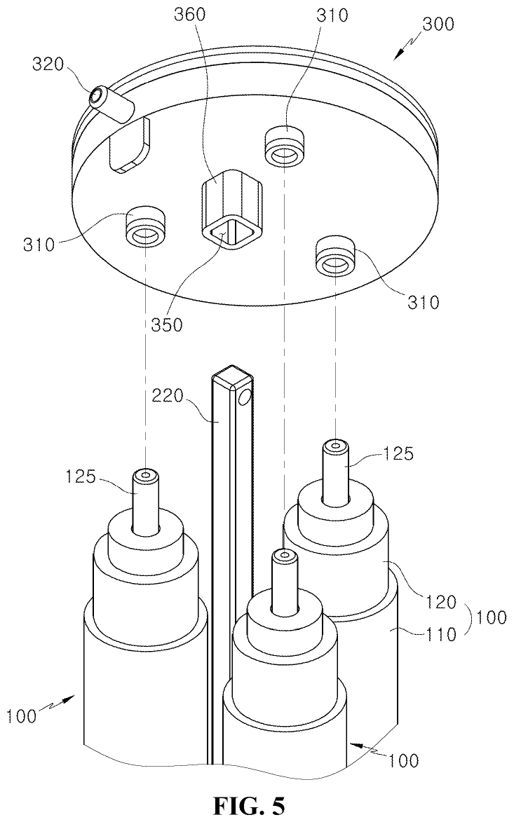

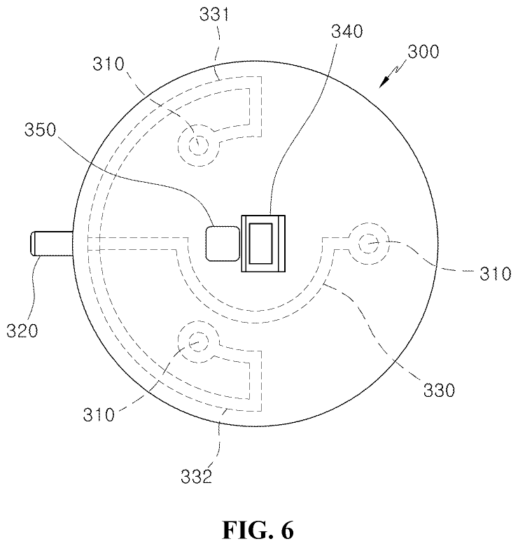

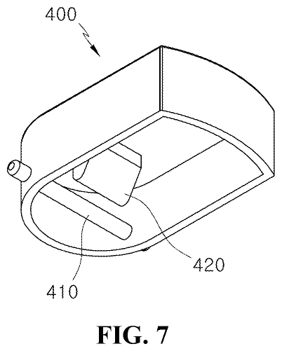

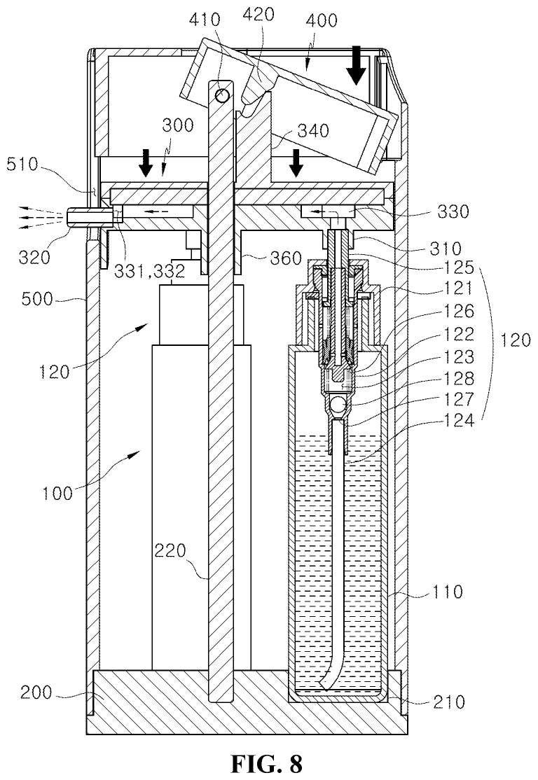

Hereinafter, a preferred embodiment of the present invention will be described in detail with reference to the accompanying drawings. Briefly explaining the accompanying drawings, FIGS. 1 to 7 illustrate the construction of a cosmetic container assembly according to the present invention. FIG. 8 illustrates the operation of the cosmetic container assembly according to the present invention.

<Description of the Construction of the Cosmetic Container Assembly According to the Present Invention>

First, the construction of the cosmetic container assembly according to the present invention will be described.

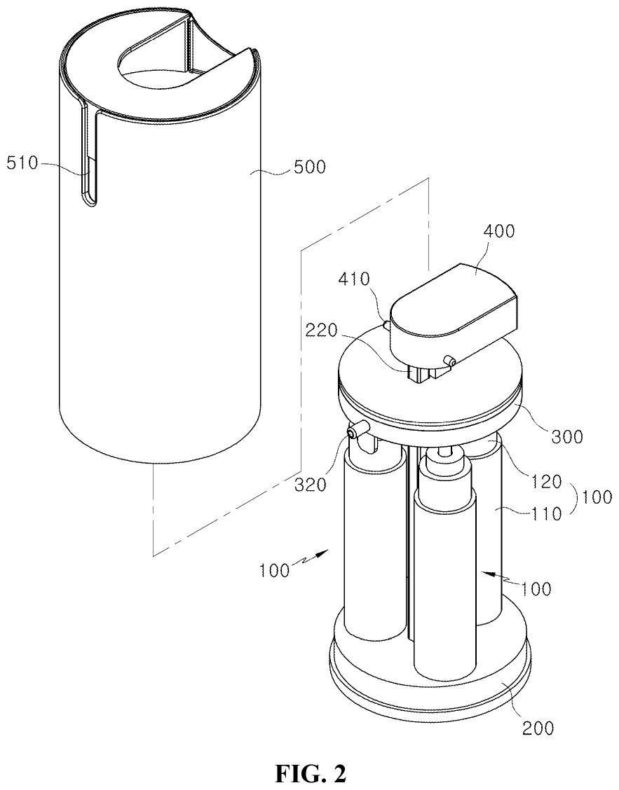

The cosmetic container assembly according to the present invention is intended to simultaneously discharge multiple kinds of contents through a single pumping action. As illustrated in FIGS. 1 and 2, the cosmetic container assembly according to the present invention includes a plurality of cosmetic containers 100, each of which includes a container 110 containing therein contents and a pump dispenser 120 mounted to the container 110, a base 200 on which the plurality of cosmetic containers 100 are arranged at regular intervals, a press plate 300, which is horizontally disposed above the cosmetic containers 100 and is configured to simultaneously press the pump dispensers 120 of the cosmetic containers 100 to thus discharge the contents in the containers to the outside, a lever push button 400 configured to press the press plate 300 using the principle of a lever, and a container housing 500, which is disposed around the cosmetic container 100 and the press plate 300 so as to surround the same.

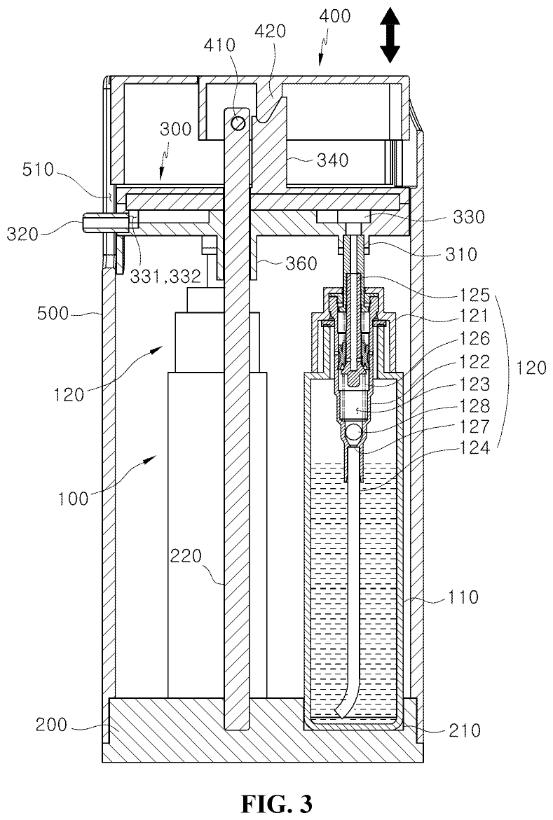

Referring to FIGS. 2 and 3, each of the plurality of cosmetic containers 100 includes the container 110, which contains therein contents and is open at the upper end thereof, and the pump dispenser 120, which is mounted in the open end of the container 110 so as to pump the contents of the container 110 to thus extrude the contents upwards through a hollow piston rod 125 through a repeated pressing action of the piston rod 125. The pump dispenser 120 includes a cap 121 mounted on the open end of the container 110, a cylinder 122, which is disposed inside the cap 121 at the center thereof and defines therein a pressure chamber 123, into which the contents are sucked through a suction tube 124 and temporarily stored, a hollow piston rod 125, the lower end of which is received in the cylinder 122 so as to be moved vertically and the upper end of which extends upwards through the central region of the cap 121, a coil spring 126, which is disposed in the cylinder 122 so as to elastically support the piston rod 125 upwards, and a ball-shaped check valve 128 configured to open and close an inlet port of the lower end of the cylinder 122 depending on variation in the pressure in the pressure chamber 123. In the pump dispenser 120, when the piston rod 125 is lowered by external force, the pressure in the pressure chamber 123 is increased, extruding the contents temporarily stored therein upwards through the hollow in the piston rod 125. When the external force applied to the piston rod 125 is removed, the piston rod 125 is raised by the elastic restoring fore of the coil spring 126, and the check valve 128 is also raised and is opened so as to allow the contents in the container 110 to be sucked into the suction tube 124.

As illustrated in FIGS. 2 and 3, the base 200 is intended to allow the plurality of cosmetic containers 100 to be disposed thereon at regular intervals in the state of being erected. Accordingly, the base 200 is provided in the upper surface thereof with a plurality of recesses 210 such that the lower portions of the containers 110 of the cosmetic containers 100 are seated in the recesses 210. In this embodiment of the present invention, the disc-shaped base 200 is configured such that three cosmetic containers 100 are disposed on the upper surface of the base 200 at intervals of 120 degrees. Furthermore, the base 200 is provided in the center thereof with a button-supporting shaft 220, which extends upwards. The button-supporting shaft 220 is intended to allow the lever push button 400, which is actuated according to the principle of a lever, to be mounted thereto and to support upward and downward movement of the press plate 300.

As illustrated in FIGS. 3 to 6, the button-supporting shaft 220 extends through the center of the press plate 300, and the press plate 300 is horizontally disposed above the cosmetic containers 100. In the embodiment of the present invention, the press plate 300 is composed of a disc-shaped plate having a predetermined thickness, and is provided in the lower surface thereof with connection ports 310 at regular intervals (intervals of 120 degrees), into which the upper ends of the piston rods 125 of the pump dispensers 120 are fitted. Furthermore, the press plate 300 is provided at the periphery thereof with an outlet port 320 so as to discharge the contents therein while mixing the contents with each other. The press plate 300 is provided therein with discharge channels 330, 331 and 332, which connect the connection ports 310 with the discharge port 320. A support shaft 340 projects upwards from the center of the upper surface of the press plate 300. The reason for this is to move the press plate 300 downwards to thus simultaneously press the piston rods 125 of the pump dispensers 120 when the lever push button 400 is pushed. Furthermore, because a shaft guide 360 is provided around a shaft through hole 350, through which the button-supporting shaft 220 extends, so as to surround the outer surface of the button-supporting shaft 220, the press plate 300 is capable of being moved upwards and downwards along the button-supporting shaft 220 without inclination thereof.

As illustrated in FIGS. 3, 4 and 7, the upper end of the lever push button 400 is rotatably coupled to the upper end of the button-supporting shaft 220 via a shaft 410. The lower surface of the front end of the lever push button 400 is provided with a press protrusion 420, which is configured to press the support shaft 340 of the press plate 300 in the state of being in contact therewith. Because the lever push button 400 employs the principle of a lever, the press protrusion 420 is capable of pressing the press plate 300 with a considerable force even when the rear end of the lever push button 400 is only lightly pressed (see the arrow direction in FIG. 3). Consequently, even when the rear end of the lever push button 400 is lightly pressed, the press plate 300 is pressed downwards, and the pump dispensers 120 of the cosmetic containers 100 are simultaneously pressed, thereby performing the pumping action.

As illustrated in FIGS. 1 and 3, the container housing 500 is disposed around the cosmetic containers 100 and the press plate 300 so as to surround the same, and defines the appearance of the cosmetic container assembly. An opening slot 510 is vertically formed in the wall of the container housing 500 so as to allow the outlet port 320 to be exposed to the outside.

<Description of Operation and Effect of the Cosmetic Container Assembly According to the Present Invention>

Hereinafter, the operation and effects of the cosmetic container assembly according to the present invention, which is constructed as described above, will be described with reference to FIGS. 3 and 8.

As illustrated in FIG. 3, in the initial state of the cosmetic container assembly according to the present invention, the piston rods 125 are in the state of being raised by the elastic restoring force of the coil springs 126 of the pump dispensers 120 of the cosmetic containers 100, and the press plate 300 is also in the state of being raised.

As illustrated in FIG. 8, when the rear end of the lever push button 400 is pressed (see the arrow direction in FIG. 8), the press protrusion 420 presses the support shaft 340, thus lowering the press plate 300. Accordingly, the piston rods 125 of the pump dispensers 120 of the cosmetic containers 100 coupled to the press plate 300 are simultaneously lowered while overcoming the elastic restoring force of the coil springs 126. When the piston rods 125 are lowered, the pressure in the pressure chambers 123 is increased, and thus the contents contained in the pressure chambers 123 are extruded upwards through the hollow in the piston rods 125. The contents extruded through the pump dispensers 120 of the cosmetic containers 100 are directed toward the outlet port 320 through the discharge channels 330, 331 and 332, and are discharged to the outside while being mixed with each other through the discharge port 320 (see the dotted arrow direction in FIG. 8).

When the force applied to the rear end of the lever push button 400 is released, the piston rods 125 of the cosmetic containers 100 are raised by the elastic restoring force of the coil springs 126, and the check valve 128 is opened, whereby the contents contained in the containers 110 are sucked into the suction tubes 124. At this point, because the piston rods 125 are raised, the press plate 300 and the lever push button 400 are maintained in the initial state thereof.

By virtue of the repeated pressing action of the rear end of the lever push button 400, the contents contained in the cosmetic containers 100 are transferred to the outlet port 320 through the pressure chambers 123 in the cylinders 122, the hollow in the piston rod 125, and the discharge channels 330, 331 and 332, and are discharged to the outside while being mixed with each other through the discharge port 320.

In other words, the cosmetic container assembly according to the present invention is constructed such that, when the rear end of the lever push button 400 is pressed, the press plate 300 is lowered and thus the pump dispensers 120 of the cosmetic containers 100 are pressed simultaneously, whereby the contents are extruded and discharged simultaneously while being mixed with each other through the outlet port 320. Particularly, it is possible for the pump dispensers 120 of the cosmetic containers 100 to simultaneously pump the contents in response to an action of lightly pressing the rear end of the lever push button 400 by virtue of the principle of a lever. Consequently, the contents in the cosmetic containers 100 are discharged in equal amounts without leaving residue therein through a single pumping action.

In addition, because the cosmetic container assembly according to the embodiment of the present invention is constructed such that the press plate 300 is moved upwards and downwards without inclination thereof by means of the shaft guide 360 surrounding the button-supporting shaft 220, it is possible for the pump dispensers 120 of the cosmetic containers 100 to pump the contents in equal amounts.

Although the cosmetic container assembly of the present invention has been described according to an embodiment to which three cosmetic containers 100 are applied, various numbers of cosmetic containers 100, such as two or four cosmetic containers 100, may be applied to the cosmetic container assembly without being limited thereto.

### INDUSTRIAL APPLICABILITY

The present invention may be extensively applied to [cosmetic container assemblies] capable of simultaneously mixing and discharging contents contained in different containers through a single pumping action.

1. A cosmetic container assembly capable of simultaneously discharging multiple kinds of contents through a single pumping action comprising:
a plurality of cosmetic containers (100), each of which includes a container (110), which contains contents therein and is open at an upper end thereof, and a pump dispenser (120), which is mounted in the open end of the container (110) and is capable of pumping the contents in the container (110) to extrude the contents upwards through a hollow piston rod (125) by repeated pressing action of the piston rod (125);
a base (200), on which the plurality of cosmetic containers (100) are disposed at regular intervals and which is provided in the center thereof with a button-supporting shaft (220), which extends upwards;
a press plate (300), which is horizontally disposed above the cosmetic containers (100) and through a central region of which the button-supporting shaft (220) extends, the press plate (300) including connection ports (310) formed in a lower surface thereof at regular intervals so as to allow upper ends of the piston rods (125) of the pump dispensers (120) to be fitted thereinto, a discharge port (320) formed in a periphery thereof so as to discharge the contents, discharge channels (330, 331 and 332) formed therein so as to connect the connection ports (310) with the discharge port (320), and a support shaft (340) formed on an upper surface thereof so as to project upwards; and
a lever push button (400), which is rotatably coupled at a front end thereof to an upper end of the button-supporting shaft (220) and is provided on a lower surface of the front end thereof with a press protrusion (420) configured to press the support shaft (340) of the press plate (300) and which is configured to move the press plate (300) downwards and thus to simultaneously press the pump dispensers (120) of the cosmetic containers (100) to perform a pumping action when a rear end of the lever push button (400) is pressed.

2. The cosmetic container assembly according to claim 1, wherein the press plate (300) includes a shaft guide (360), which is formed around a shaft through hole (350), through which the button-supporting shaft (220) extends, so as to surround an outer surface of the button-supporting shaft (220) such that the press plate (300) is moved upwards and downwards along the button-supporting shaft (220) without inclination thereof.

3. The cosmetic container assembly according to claim 1, further comprising a container housing (500), which is disposed around the cosmetic containers (100) and the press plate (300) so as to surround the same.
